(19) United States
(12) Patent Application Publication
(10) Pub. No.: US 2005/0177466 A1
(43) Pub. Date: Aug. 11, 2005

(54) Method and apparatus for aggregation reconciliation through hierarchical tag checksums

(76) Inventor: Bruce A. Willins, East Northport, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/749,795

(22) Filed: Dec. 31, 2003

(51) Int. Cl. G06F 17/60

(52) U.S. Cl. 705/28

(57) ABSTRACT

A hierarchical system of tag associations reduces latency and bandwidth consumption in an RFID or other environment. A method of electronically tracking a items (such as retail goods) stored in a container includes the broad steps of obtaining the electronic identifier for each of the items, computing a checksum or alternative high entropy data structure as a function of each of the electronic identifiers, and transmitting the checksum or data structure to the container for storage at the container. The stored data structure can be compared against a subsequently-calculated checksum to identify any changes to the items stored in the container.

### TECHNICAL FIELD

The present invention generally relates to item tracking systems, and more particularly relates to devices and techniques for aggregating items for improved item tracking. Various embodiments may be implemented in a radio frequency identification (RFID) environment.

### BACKGROUND

Radio frequency identification (RFID) transponders are increasingly being used to identify and track individual items such as goods in a warehouse or retail establishment. RFID transponders (more commonly called “tags”) are small, low-cost computer chips that are capable of storing data (e.g. a serial number, product number or other identifying information) and of providing the stored data to a reader, typically via a wireless connection. Manufacturers and packagers are increasingly including RFID tags on their products to aid in product identification, inventory management, and other tasks.

Within the retail chain, goods are often bundled in various packaging containers such as boxes, cartons, crates, cases, pallets or the like. In a conventional RFID system such as the system shown in FIG. 1, each item and container has a tag with a unique identifier. Each identifier is typically maintained in a back-end server, along with a record of the various associations between tags. To verify that a pallet or other container has not been “broken” (i.e. items removed) or otherwise modified, the backend server typically needs to obtain the identities of each tag corresponding to every item stored within the container. As a pallet of goods approaches a portal or other RFID reader, for example, the reader obtains tag information from each item and container and transports the various tag identifiers to the backend server for processing. The server evaluates the various identifiers received with records stored in the database, and identifies any discrepancies.

While the technique of reading all of the tags can effectively identify changes in makeup of a pallet or other container in many situations, it does exhibit a number of marked disadvantages. Most notably, transmitting the data for every tag on the pallet to the backend server can consume a large amount of bandwidth, which is particularly problematic if the link between the reader and the server is a low-bandwidth wireless connection or a no bandwidth (e.g. a “batch mode”) connection. Further, the amount of traffic created by the multiple tag reads can increase the amount of interference, cross-talk or other noise present within an RFID environment. Moreover, the latency created by the lengthy process of reading all the tags and transporting all of the tag identifiers to the server for processing can be significant. Since a conventional RFID reader can read approximately 200 tags per second, the pallet may need to be delayed as it passes near the reader to ensure adequate reads of all of the tags. Alternatively, the pallet may have already passed through the portal or otherwise moved further down the retail chain before tampering or changes in the pallet are identified. Moreover, the process of reading many tags can be susceptible to inaccuracy resulting from crosstalk between readers, timing issues in sorting simultaneous responses from multiple tags, and other factors.

Accordingly, it is desirable to create devices and techniques that are able to quickly and accurately identify changes or discrepancies from shipment in items stored within containers. In addition, it is desirable to create systems and techniques that conserve bandwidth and system loads while increasing response times and reducing cross-talk, interference and other noise. Furthermore, other desirable features and characteristics of the present invention will become apparent from the subsequent detailed description and the appended claims, taken in conjunction with the accompanying drawings and the foregoing technical field and background.

### BRIEF SUMMARY

A hierarchical system of tag associations reduces latency and bandwidth consumption in an RFID or other environment. In various embodiments, a method of electronically tracking items (such as retail goods) stored in a container includes the broad steps of obtaining the electronic identifier for each of the items, computing a checksum or other representation of the electronic identifiers, and transmitting the checksum or other representation to an electronic tag or other identifier associated with the container itself for storage. The stored checksum or other representation can be compared against a subsequently-calculated checksum/hash to identify any changes to the items stored in the container. The stored checksum/representation can be accompanied with additional data such as tag counts, filters and/or the like.

In another aspect, a reader device for electronically tracking items suitably includes a transceiver and a processor. The transceiver is configured to communicate with RFID or similar tags associated with the various items. The processor is configured to obtain identifiers from each of the tags associated with items, to compute a representation of the identifiers as a function of each of the identifiers, and to transmit the representation to the tag associated with the container via the transceiver for storage at the container. The device may also be configured to retrieve the stored representation and to compare it against a second representation calculated at a later time to verify that the contents of the container have not changed.

Other aspects include data processing systems for tracking items as well as data structures, wireless signals modulated on a carrier wave, RFID tags, and the like.

### BRIEF DESCRIPTION OF THE DRAWINGS

The present invention will hereinafter be described in conjunction with the following drawing figures, wherein like numerals denote like elements, and

FIG. 1 is a block diagram of a prior art RFID portal system;

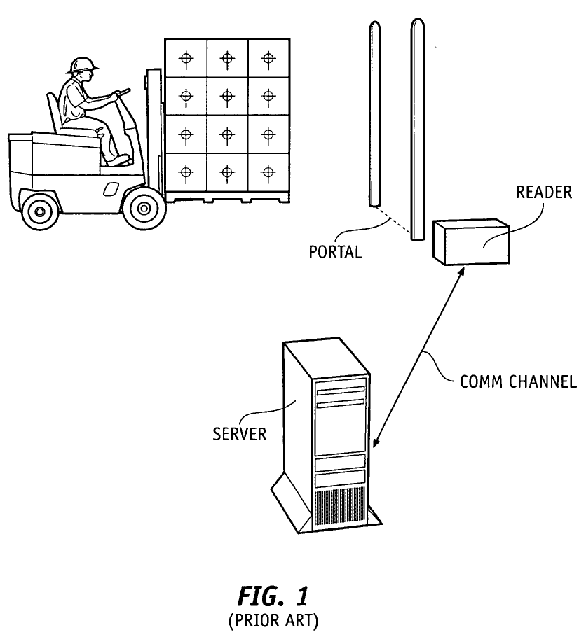

FIG. 2 is a block diagram of an exemplary hierarchical RFID tag structure;

FIG. 3 is a data flow diagram showing an exemplary technique for generating checksum information;

FIG. 4 is a data flow diagram showing an exemplary technique for verifying a checksum stored in a container; and

FIG. 5 is a data flow diagram showing an exemplary technique for reconciling cross-talk between two portal readers.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, a hierarchical structure of tag associations provides the ability to aggregate data about multiple items and/or containers at the reader, thereby reducing the amount of data transported to the back-end server. Instead of transporting data from every tag back to the central server over a data channel, the reader appropriately computes a checksum or other representation of the various identifiers received and stores the representation in a tag associated with the container. To detect subsequent changes to the contents of the container, the reader simply reads in the identifiers for the various items stored in the container, computes a second representation, and then compares the more recently computed representation to the representation previously stored in the container's tag. If the two representations match, the reader can be relatively confident that the contents of the container have not changed since the previous representation was computed. The representation need only be relatively small in size (e.g. on the order of 32 bits) for effective detection of missing items, making it conducive to the limited storage of the container tag. Furthermore, the representation may be augmented with a simple tag count and/or filter to prevent failed detections caused by reading nearby tags outside of the container. This general principal may be applied in a number of contexts and settings, and may be enhanced or modified in many ways, as set forth in detail below.

As used herein, the term “container” is intended to broadly encompass any packaging or transporting mechanism that is capable of aggregating items and/or other containers into a common unit. Examples of containers include packages, packets, boxes, cases, crates, cartons, envelopes, shrinkwrapped or cellophane packaging and/or the like.

Similarly, the term “checksum” is intended to broadly encompass any checksum, CRC, digest, data structure or other compressed representation of other data. Generally speaking, a checksum is representative of a stream or set of data, but itself has fewer data bits than the represented data. In this setting, a “checksum” could include any compressed data representation of the contents of a data structure or set that is computed according to any algorithm or that exhibits any form or structure. Typically checksums have a relatively high-entropy with respect to the represented data, although the term “high entropy” is a relative term that is dependent upon context.

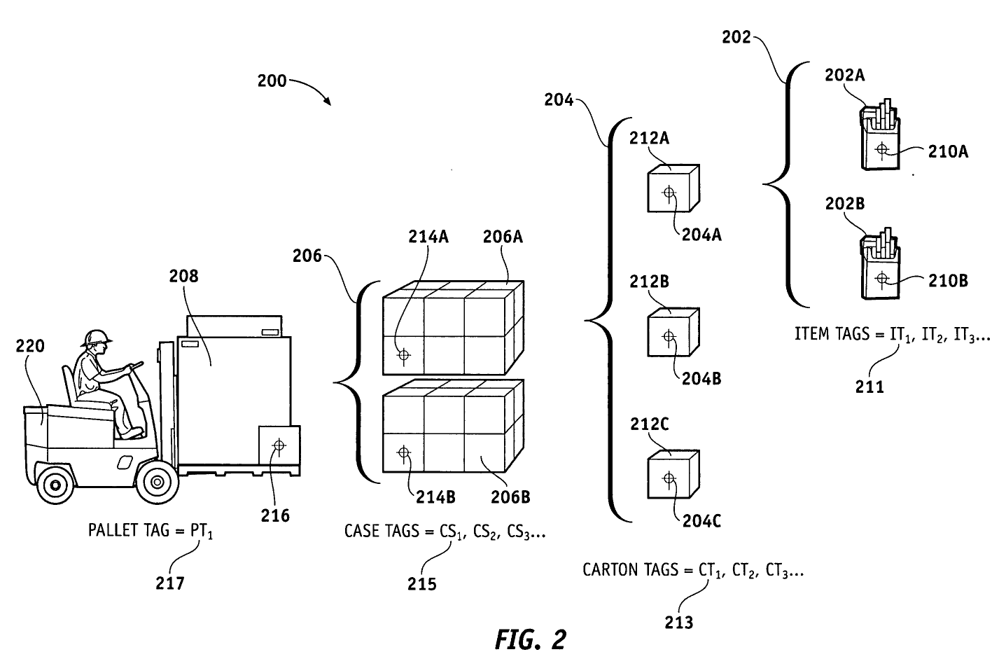

With reference now to FIG. 2, an exemplary hierarchical structure 200 for allocating RFID or other tags suitably includes any number of items 202 contained within any number of containers 204, 206, 208. Each of the items 202 and containers 204, 206, 208 suitably include RFID or similar tags 210, 212, 214, 216 (respectively).

Each tag 210, 212, 214 and 216 is any chip, processor, circuit or other device capable of storing identifying information and of providing the identifying information as requested by a reader device. In various embodiments, tags 210, 212, 214 and 216 are implemented as radio frequency identification (RFID) transceivers, which are widely available from a variety of commercial sources. Tags are available in active or passive format, and either may be used with the concepts set forth herein. Some or all of the tags used within hierarchy 200 may optionally be tamper resistant and/or environmentally sensitive, as appropriate for the particular embodiment and operating environment.

Many products are conventionally packaged in a hierarchical manner, with items packed within containers, and the various containers being packed within larger containers. Cigarettes, for example, are generally transported and sold in packs 202, with the packs 202 being packaged in cartons 204, and cartons 204 packaged in cases 206. Multiple cases 206 may be stacked or otherwise placed upon a pallet 208 or other structure for storage and/or transport as appropriate. The various tags 210, 212, 214 and 216 similarly have a hierarchical association with each other based upon this packaging hierarchy. Each item 202A-B, for example, has an associated tag 210A-B as appropriate. Similarly, each carton 204A-C has an associated tag 212A-C, and each case 206A-B has an associated tag 214A-B.

Each tag 210, 212, 214 and 216 typically includes an associated identifier 211, 213, 215 and 217 (respectively), which may be any numerical or other digital code such as an electronic product code (EPC), serial number and/or the like. In various embodiments, each tag has a unique bit sequence or other identifier that can be associated with a particular product, item or container as appropriate. EPC codes, for example, are typically ninety-six bits in length, including a forty bit serial number, and are used to identify various products and items in the stream of commerce according to standards promulgated by the Uniform Code Council (UCC).

Generally speaking, tags 210 associated with items 202 or other lower levels of the hierarchy will be more numerous than tags associated with higher levels, thereby providing an incentive to select low level tags to be relatively low in cost in many embodiments. Successively higher-level tags may be fewer in quantity, and can therefore bear additional cost and sophistication, as appropriate and as described below. In particular, pallet tags 216, case tags 214 and/or carton tags 212 (collectively “container tags”) may be designed to support an additional data field containing an identifier corresponding to the aggregate of the contents of the container. This data field will typically be a write-able field that is capable of receiving a checksum or other code from an external device and maintaining the code in memory until the code is retrieved. Alternatively, some or all of the container tags may be “write once/read many” tags capable of receiving a code from an external device in a manner that is not modifiable after the code is stored in the tag.

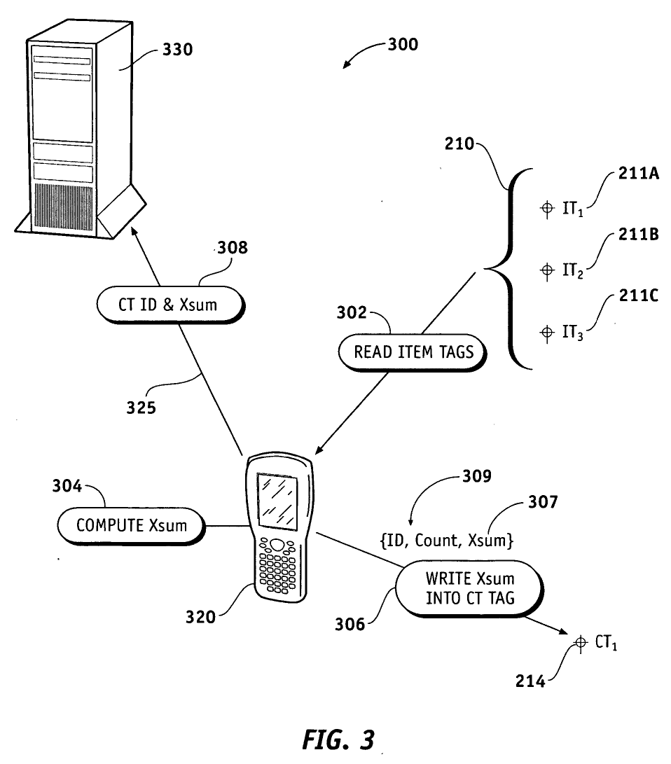

An exemplary data structure for a container tag (e.g. tags 213, 215 and/or 217 in FIG. 2) may take the format of:
PT₁={ID, Item_Count, Content_Association {P(CS₁, CS₂ . . . CSₙ)}}
where “ID” is a unique identifier for the container tag, “Item_Count” is an optional count of the items (or other containers) stored within the container, and the “Content_Association” field is a hash, digest, checksum, bit stream or other compressed aggregate of data that is indicative of the contents of the container. Various techniques for computing the “Content_Association” field are described in conjunction with FIG. 3 below.

In operation, then, hierarchy 200 suitably provides a structure whereby items 202 and containers 204, 206, 208 have a hierarchical association with each other. Each tag is configured with a unique identifier, and some or all of the containers further maintain a Content_Association field with data about the container's contents, as appropriate.

The hierarchy 200 described in FIG. 2 is intended as exemplary, and other products and embodiments may exhibit different hierarchical arrangements 200. Certain products (e.g. televisions) may be packaged only at the pallet level 208, for example, whereas other products (e.g. candy, foodstuffs) may have even more levels of packaging in their hierarchies 200. Other products may be packaged and transported in a wide array of alternate ways. Accordingly, the hierarchy 200 shown in FIG. 2 will vary substantially from embodiment to embodiment. While hierarchy 200 may be considered to be logical in nature and may not be physically recorded or otherwise tangibly perceptible in all embodiments, hierarchy 200 is nevertheless useful for aggregating information about lower level items and/or containers, as described more fully below.

With reference now to FIG. 3, an exemplary data flow process 300 for storing aggregation data in a container tag suitably includes the broad steps of obtaining tags from the items/sub-containers stored in the container (step 302), computing a checksum or other representation as a function of each of the obtained tags (step 304), and writing the checksum/representation to the container tag (step 306).

Process 300 may be executed at any reader device 320, including any handheld reader, portal reader, wearable reader, or other reader located on a ceiling, shipping dock, floor, wall or any other location. Conventional readers 320 in the RFID environment, for example, typically include a transceiver and antenna for transmitting and receiving radio frequency (RF) signals to and from the various tags in the operating environment. Reader 320 also includes a conventional microprocessor and memory for processing data and controlling communications with the various tags. The various processing steps of process 300, for example, may be stored in any electronic form (e.g. RAM, ROM, Flash memory, EEPROM, etc.) and executed by the processor within reader 320. In further embodiments, reader 320 also interfaces with a back-end server 330 via a data channel 325 as appropriate for data storage, security and other features. In various embodiments, data channel 325 is any optical, electrical or wireless connection such as an IEEE 802.3 network connection or IEEE 802.11 wireless connection, although any other type of data channel could be used in a wide array of alternate embodiments.

Process 300 may be executed at any time during the supply chain, such as at pallet formation, crate/carton/case packing, initiation of transport, or at any other time. Reader 320 obtains the data from the item tags 210 using any suitable technique (step 302), such as a conventional RFID tag read process as defined by various RFID standards and practices. Reading the tag obtains the identifier information 211A-C stored on each tag 210, as appropriate.

After the tag identifiers 211A-C are read, reader 320 processes the received tags (step 304) to compute an appropriate checksum 307 or other representation to be stored in the Content_Association field of the container tag 214. Checksum 307 can be created in any manner, but in most embodiments the checksum is computed as a function of each of the tag identifiers 211A-C received from the next-lower level of tags in hierarchy 200 (e.g. cases to a pallet, cartons to a case, items to a carton). Suitable functions include various hash functions, cyclic redundancy codes (CRCs), message digest algorithms (e.g. the MD4 and MD5 algorithms described in Internet RFCs 1320 and 1321, respectively) or the like. In various embodiments, the representation may include a description of a hash function along with hashed values describing each of the tags in a smaller bit representation. Numerous other data processing functions, routines and structures could be used to implement the checksum function. Similarly, checksum 307 may be implemented with any compressed and/or high-entropy data function or structure. A string of ninety-six bit EPC codes, for example, could be represented by a single thirty-two bit (or smaller) checksum.

In various embodiments, the checksum function is a simple polynomial divider algorithm such as those commonly used for error detection in digital communications systems (e.g. CRC-CCITT32 or CRC-CCITT16), although any other algorithm could be used in a wide array of alternate embodiments. Polynomial divider functions may be readily implemented with simple shift registers and combinatorial logic, or in any other manner. Alternatively, checksum 307 may be computed with a “one-way” or non-invertible function such that items may be easily added to the container but not removed without recalculating the entire checksum 307. This feature may be particularly useful as pallets or other containers are being built, for example.

After the checksum is calculated, it is transmitted to the container tag 214 for storage until subsequent retrieval (step 306). Transmission may take place using conventional RFID or other techniques. Typically, reader 320 formulates a data structure 309 similar to the container structure shown above that includes the identifier (ID) for the container tag 214, as well as checksum 307 and an optional item count. Alternatively, reader 320 may simply transmit checksum 307 and any item count to tag 214, and container tag 214 formats the data structure with its own ID and stores the resultant structure in memory as appropriate.

Reader 320 may also transmit checksum 307 to server 330 via data channel 325 as appropriate (step 308). In various embodiments, enhanced security is provided by computing checksum 307 using a nonce (i.e. a randomly created value). The nonce can then be stored on server 330 (or in another secure location) to prevent other devices from recalculating and storing a new checksum 307 on container tag 214. That is, by restricting nonce access to those devices able to authenticate to server 330, unauthorized tampering or recalculation of checksum 307 based upon the nonce value can be prevented.

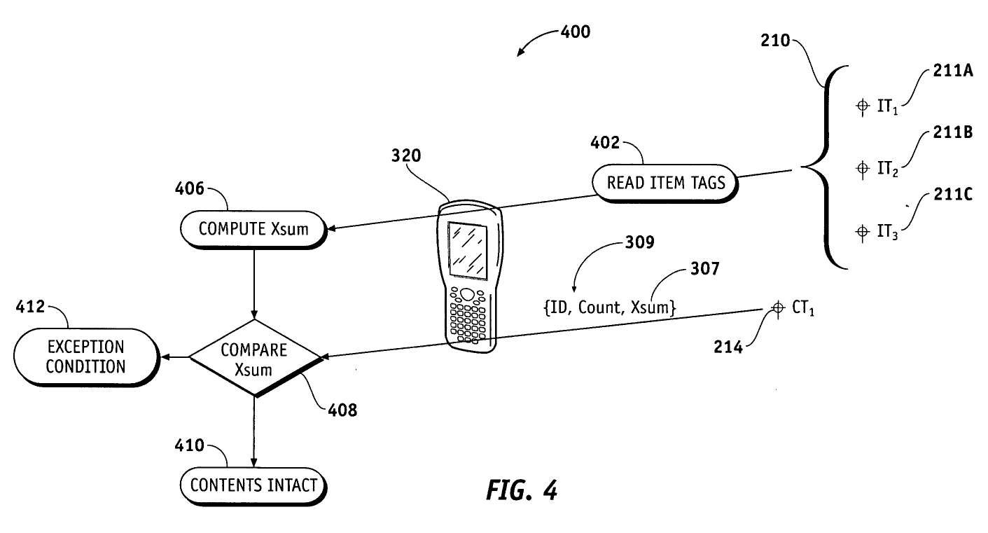

In embodiments wherein still more security is desired, reader 320 digitally signs checksum 307 (or another associated bit stream) in step 304 prior to transmittal to container tag 214. This signature is made with a private key maintained by reader 320 using any appropriate asymmetric cryptographic technique. Upon subsequent retrieval (see FIG. 4 below), the signature can be decrypted using a public key associated with reader 320, which may optionally be verified by checking a certificate provided by server 330 or another source. In such embodiments, the authenticity of checksum 307 is further enhanced by verifying the identity of the device computing the digital signature prior to storage. Security may be even further enhanced by using a “write once/read many” tag that cannot be modified after the initial checksum 307 is written to tag 214, thereby further permitting any tampering with checksum 307 and enhancing the security of the system.

With reference now to FIG. 4, an exemplary process 400 for reading and verifying a checksum 307 for a container suitably includes the broad steps of reading the tag identifiers from the items contained within the container (step 402), reading tag data 309 including checksum 307 from container tag 214 (step 404), computing a second checksum from the newly-read tag identifiers (step 406), and comparing the second checksum with checksum 307 retrieved from container tag 214 (step 408). If the two checksums match (step 410), it can be concluded that the contents of container 214 have not changed since checksum 307 was originally computed. In this case, reader 320 may opt to stop additional tag polling, thereby saving terminal power, increasing battery life and reducing the probability of producing cross-talk or interference with another reader. If the two checksums do not match (step 412), it may be concluded that at least one item has been added and/or subtracted from the container after checksum 307 was computed, or that at least one item has failed the tag read. In such cases, reader 320 may opt to continue scanning for additional tags, or may repeat step 402 in hopes of identifying at least one tag that failed to respond or that was improperly read by reader 320. Alternatively, reader 320 may identify the exception condition with a flag or alarm, thereby prompting further inspection by a human or machine operator or other appropriate action. In further embodiments with enhanced security, process 400 may also include authenticating with a server 330 (FIG. 3) to obtain a nonce, verifying a digital signature in data structure 309, or any other appropriate actions.

Because the checksums stored within the various containers in hierarchy 200 (FIG. 2) are self-checking, the amount of data being transmitted to and from the server 330 is dramatically reduced and/or eliminated. Moreover, since the reader 320 is able to verify the integrity of the various containers and their contents without additional input from server 330 in various embodiments, processing demands upon the server are reduced, as well as the latency associated with many prior art methods. Further, by reducing the level of wireless communication occurring with system, cross-talk and other associated noise is appropriately reduced.

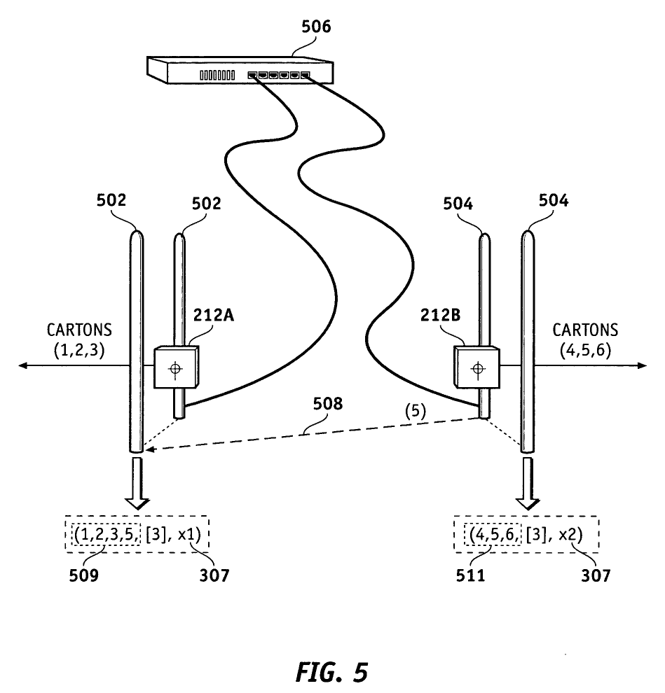

Moreover, the concepts described above may be used to reconcile the effects of cross-talk even further by allowing for received data to be exchanged between portals or other readers 320 without affecting traffic to server 330. With reference now to FIG. 5, two containers 212A (carrying items 1, 2 and 3) and 212B (carrying items 4, 5 and 6) are shown traveling through two portals 502 and 504, respectively. Due to the close proximity of portals 502 and 504, some cross-talk occurs as portal 502 receives a tag identifier from item 5 (shown as signal 508 in FIG. 5). As each portal computes the checksums 307 for items observed in the container 212, portal 502 obtains a false fault reading due to cross-talk 508. This is shown in data structure 509, which shows that portal 502 has read items 1, 2, 3 and 5. Portal 502 recognizes that an extra item was identified from the item count received from container 212A, while portal 504 obtains a successful verification of checksum 307 in data structure 511. Portal 502 therefore contacts portal 504 via a data network 506 (which may be any wired or wireless network) to obtain a listing of items identified at portal 504. By comparing the lists of items in data structures 509 and 511, portal 502 is able to identify that the reading of item 5 was the result of cross-talk. Accordingly, portal 502 can ignore item 5 when re-calculating checksum 307 to obtain a successful verification. The use of self-checking mechanisms such as checksums therefore allows for numerous opportunities for data sharing between portals, handheld readers and other readers.

Although the invention is frequently described herein as applying to RFID tags used in a warehousing or retail environment, the concepts and structures described herein may be readily adapted to a wide array of equivalent environments. The hierarchical structure of checksums, for example, could be applied in a governmental, defense or industrial setting, as well as in any banking, commercial or personal setting. The concepts of tagging and aggregation may be used to track any collection of goods or items, and are not limited to the exemplary goods contained herein. Further, the concepts contained herein are not limited to the conventional RFID environments, but may be readily adapted to any other item identification technologies presently known or subsequently developed, including any active or passive technologies based upon electromagnetic, optical or other data storage and/or transmission techniques.

While at least one exemplary embodiment has been presented in the foregoing detailed description, it should be appreciated that a vast number of variations exist. Similarly, the various structures and techniques described herein are provided for purposes of illustration only, and may vary widely in various practical embodiments. Accordingly, the various embodiments described herein are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that numerous changes can be made in the selection, function and arrangement of the various elements without departing from the scope of the invention as set forth in the appended claims and the legal equivalents thereof.

1. A method of electronically tracking a plurality of items stored in a container, wherein each of the plurality of items comprises an electronic identifer, the method comprising the steps of:
obtaining the electronic identifier for each of the plurality of items;
computing a data representation as a function of each of the plurality of electronic identifiers; and
transmitting the data representation to the container for storage at the container.

2. The method of claim 1 further comprising the steps of:
repeating the obtaining and computing steps at a subsequent time to determine a second data representation;
retrieving the data representation from the container; and
comparing the data representation from the container with the second data structure to thereby identify changes in the items stored in the container.

3. The method of claim 1 further comprising the step of transmitting the data representation to a server.

4. The method of claim 3 wherein the transmitting step comprises transmitting an identifier for the container to the server with the data representation.

5. The method of claim 4 further comprising the steps of:
repeating the obtaining and computing steps at a subsequent time to determine a second data representation;
retrieving the data representation from the server; and
comparing the data representation from the container with the second data representation to thereby identify changes in the items stored in the container.

6. The method of claim 1 wherein the obtaining, computing and transmitting steps are performed by an RFID reader.

7. The method of claim 1 further comprising the steps of:
obtaining container data structures from each of a plurality of containers stored on a pallet;
computing a pallet data representation as a function of each of the container data structures; and
storing the pallet data representation at the pallet.

8. The method of claim 1 further comprising the step of digitally signing the data representation prior to the transmitting step.

9. The method of claim 1 wherein the data representation comprises a checksum.

10. The method of claim 1 wherein the data representation comprises a cyclic reduction code (CRC).

11. The method of claim 1 wherein the function is a hash function.

12. The method of claim 1 wherein the function comprises a message digest algorithm.

13. The method of claim 1 wherein the data representation comprises a compressed, high entropy, data representation of the contents within the container.

14. A computer-implemented method of electronically tracking a plurality of items stored in a container with an RFID reader, wherein each of the plurality of items and the container are associated with one of a plurality of RFID tags each having an RFID identifier, the method comprising the steps of:
obtaining RFID identifiers from each of the plurality of RFID tags associated with the plurality of items;
computing a checksum as a function of each of the RFID identifiers with the RFID reader; and
transmitting the checksum from the RFID reader to the RFID tag associated with the container for storage.

15. The method of claim 14 further comprising the step of digitally signing the checksum with a private key associated with the RFID reader prior to the transmitting step.

16. The method of claim 14 further comprising the steps of:
repeating the obtaining and computing steps at a subsequent time to determine a second checksum;
retrieving the checksum from the container; and
comparing the checksum from the container with the second checksum to thereby identify changes in the items stored in the container.

17. The method of claim 16 further comprising the step of communicating with a second RFID reader when the second checksum does not match the checksum from the container to identify crosstalk between the RFID reader and the second RFID reader.

18. The method of claim 17 wherein the communicating step comprises transmitting a list of the RFID identifiers obtained in the obtaining step to the second RFID reader.

19. The method of claim 17 wherein the communicating step comprises the steps of:
receiving a list of RFID identifiers from the second RFID reader; and
comparing the list of RFID identifiers from the second RFID reader with the RFID identifiers received during the obtaining step to identify any duplicate identifiers.

20. The method of claim 14 wherein the transmitting step comprises transmitting an identifier for the container to the server with the checksum.

21. The method of claim 20 further comprising the steps of:
repeating the obtaining and computing steps at a subsequent time to determine a second checksum;
retrieving the checksum from the server; and
comparing the checksum from the container with the second checksum to thereby identify changes in the items stored in the container.

22. The method of claim 21 further comprising the step of notifying a central server of a result of the comparing step.

23. A device for electronically tracking a plurality of items stored in a container, wherein each of the plurality of items and the container are associated with RFID tags each having an RFID identifier, the device comprising:
means for obtaining RFID identifiers from each of the RFID tags associated with the plurality of items;
means for computing a checksum as a function of each of the RFID identifiers associated with the plurality of items; and
means for transmitting the checksum to the RFID tag associated with the container for storage.

24. The device of claim 23 further comprising means for digitally signing the checksum with a private key associated with the device prior to the transmitting step.

25. The device of claim 23 further comprising means for comparing the checksum received from the container with a second checksum computed by the computing means as a function of RFID tags associated with the plurality of items received from the obtaining means to thereby identify changes in the items stored in the container.

26. The device of claim 23 further comprising means for communicating with a central server.

27. An RFID reader for communicating with a plurality of items stored in a container, wherein each of the plurality of items and the container are associated with one of a plurality of RFID tags each having an RFID identifier, the RFID reader comprising:
a transceiver configured to communicate with the plurality of RFID tags; and
a processor operatively configured to communicate with the transceiver to obtain RFID identifiers from each of the RFID tags associated with the plurality of items, to compute a data structure as a function of each of the RFID identifiers associated with the plurality of items, and to transmit the data structure to the RFID tag associated with the container via the transceiver for storage at the container.

28. The RFID reader of claim 27 wherein the processor is further configured to digitally sign the data structure prior to transmitting the data structure to the RFID tag associated with the container.

29. The RFID reader of claim 27 further comprising a network interface configured to communicate with a central server, and wherein the processor is further configured to transmit the data structure to the central server via the network interface.

30. The RFID reader of claim 29 wherein the processor is further configured to subsequently retrieve the data structure from the central server for comparison with a second data structure computed from a second reading of the RFID identifiers associated with the plurality of items.

31. The RFID reader of claim 27 wherein the RFID reader is a handheld reader.

32. The RFID reader of claim 27 wherein the RFID reader is associated with a portal.

33. A system for tracking a plurality of items stored in a container, wherein each of the plurality of items and the container are associated with one of a plurality of RFID tags each having an RFID identifier, the system comprising:
a data network;
an RFID reader interfacing with the data network, wherein the RFID reader is configured to obtain RFID identifiers from each of the RFID tags associated with the plurality of items, to compute a checksum as a function of each of the RFID identifiers associated with the plurality of items, and to transmit the checksum to the RFID tag associated with the container via the transceiver for storage at the container; and
a central server configured to communicate with the RFID reader via the data network to receive the checksum and to store the checksum in a database associated with the central server in conjunction with the RFID identifier associated with the container.

34. The system of claim 33 wherein the data network is a wireless network.

35. An electronic signal modulated on a carrier wave, wherein the electronic signal corresponds to an RFID tag associated with a container for a plurality of items, each item having an associated RFID item tag, the electronic signal comprising:
a first data field corresponding to an RFID identifier of the RFID tag;
a second data field corresponding to an item count of the plurality of items; and
a third data field comprising a checksum, wherein the checksum is calculated as a function of the RFID item tags for each of the plurality of items.

36. A digital storage medium having electronic data stored thereon, wherein the electronic data corresponds to a container for a plurality of items, each item having an associated RFID item tag, the electronic data comprising:
a first data field comprising an RFID identifier of container;
a second data field comprising an item count of the plurality of items; and
a third data field comprising a checksum, wherein the checksum is calculated as a function of the RFID item tags for each of the plurality of items.

37. An RFID tag associated with a container for a plurality of items, each item having an associated RFID item tag, the RFID tag comprising:
a first data field corresponding to an RFID identifier of the RFID tag;
a second data field corresponding to an item count of the plurality of items; and
a third data field comprising a checksum, wherein the checksum is calculated as a function of the RFID item tags for each of the plurality of items.
